(19) United States
(12) Patent Application Publication
(10) Pub. No.: US 2024/0282298 A1
(43) Pub. Date: Aug. 22, 2024

(54) SYSTEMS AND METHODS FOR CONVERSATION ORCHESTRATION USING LARGE LANGUAGE MODELS

(71) Applicant: KORE.AI, INC., Orlando, FL (US)

(72) Inventors: Rajkumar Koneru, Windermere, FL (US); Prasanna Kumar Arikala Gunalan, Hyderabad (IN); Thirupathi Bandam, Hyderabad (IN)

(73) Assignee: KORE.AI, INC., Orlando, FL (US)

(21) Appl. No.: 18/219,905

(22) Filed: Jul. 10, 2023

Related U.S. Application Data
(60) Provisional application No. 63/447,274, filed on Feb. 21, 2023.

(51) Int. Cl. G10L 15/183

(52) U.S. Cl. CPC G10L 15/183

(57) ABSTRACT

A virtual assistant server executes a dialog flow corresponding to a use case of one or more utterances received from a customer device. Further, a large language model (LLM) is selected from a plurality of LLMs to perform response generation based on an execution state of the dialog flow. Further, a plurality of outputs is received from the selected LLM based on a plurality of prompts provided to the selected LLM to fulfill one or more execution goals of the dialog flow. Further, when one or more of the plurality of outputs comprise: one or more entities extracted from the one or more utterances and a response to be transmitted to the customer device, the adherence of: the extracted one or more entities to one or more business rules and the response to one or more conversation rules, are validated. Subsequently, the response of the one or more of the plurality of outputs is transmitted to the customer device when the corresponding validation is successful.

This application claims the benefit of U.S. Provisional Patent Application Ser. No. 63/447,274, filed Feb. 21, 2023, which is hereby incorporated by reference in its entirety.

### FIELD

This technology generally relates to virtual assistants, and more particularly to methods, systems, and computer-readable media for conversation orchestration using large language models.

### BACKGROUND

Conversational artificial intelligence (AI) systems have become a popular customer touchpoint because of the ease of interaction they offer. Customers can converse with enterprise specific custom virtual assistants in natural language and resolve their issues or find the answers to their queries.

The development and deployment of conversational AI systems by an enterprise includes creating and managing custom virtual assistants that provide responses to enterprise customers to a fixed set of dialog flows. The enterprise creates training data sets and trains the custom virtual assistants based on predicted probable journeys that the customers may take or the questions that the customers may ask during each of the predicted probable journeys to provide responses to the questions. This is a skilled exercise and comprises heavy development costs and lengthy timelines. Huge teams including business analysts, language experts, conversation designers, developers and testers are required to develop and deploy a custom virtual assistant. Rigorous development and testing, which often takes months, is required to develop the custom virtual assistant which converses satisfactorily with customers. Further, this approach comes with an inherent limitation of being static and expecting customer situations to stay within the predicted journeys.

The existing custom virtual assistants are not adept at handling human-like complex conversations. Whereas general virtual assistants using a large language model (LLM) engage the users in natural and fluid conversations. However, the LLM cannot handle enterprise specific use cases due to drawbacks such as, for example, limited domain expertise, bias in training data, lack of personalization, limited adaptability to changing context, limited contextual understanding, hallucination, lack of control over output, inability to learn from feedback, or the like to name a few.

Hence, there is a need for systems and methods to create custom virtual assistants which can leverage LLMs to provide robust, natural, and fluid human-like conversation experience to customers.

### SUMMARY

In an example, the present disclosure relates to a method for orchestrating a customer conversation by a virtual assistant server. The method comprises: executing by the virtual assistant server, a dialog flow corresponding to a use case of one or more utterances received from a customer device, wherein the dialog flow comprises a series of interconnected nodes. Further, selecting by the virtual assistant server, a large language model (LLM) from a plurality of LLMs to perform response generation for the one or more utterances received from the customer device based on an execution state of the dialog flow. Further, receiving by the virtual assistant server, a plurality of outputs from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device. Further, when one or more of the plurality of outputs of the selected one of the plurality of LLMs comprise the one or more entities extracted from the one or more utterances and the response to be transmitted to the customer device, validating by the virtual assistant server, adherence of: the extracted one or more entities to one or more business rules and the response to one or more conversation rules. Subsequently, transmitting by the virtual assistant server, the response of the one or more of the plurality of outputs of the selected one of the plurality of LLMs to the customer device when the corresponding validation is successful.

In another example, the present disclosure relates to a virtual assistant server comprising one or more processors and a memory. The memory coupled to the one or more processors which are configured to execute programmed instructions stored in the memory to orchestrate a customer conversation at the virtual assistant server by executing a dialog flow corresponding to a use case of one or more utterances received from a customer device, wherein the dialog flow comprises a series of interconnected nodes. Further, a large language model (LLM) is selected from a plurality of LLMs to perform response generation for the one or more utterances received from the customer device based on an execution state of the dialog flow. Further, a plurality of outputs is received from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device. Further, when one or more of the plurality of outputs of the selected one of the plurality of LLMs comprise the one or more entities extracted from the one or more utterances and the response to be transmitted to the customer device, the adherence of: the extracted one or more entities to one or more business rules and the response to one or more conversation rules, are validated. Subsequently, the response of the one or more of the plurality of outputs of the selected one of the plurality of LLMs is transmitted to the customer device when the corresponding validation is successful.

In another example, the present disclosure relates to a non-transitory computer readable storage medium having stored thereon instructions which when executed by one or more processors, causes the one or more processors to orchestrate a customer conversation at the virtual assistant server by executing a dialog flow corresponding to a use case of one or more utterances received from a customer device, wherein the dialog flow comprises a series of interconnected nodes. Further, a large language model (LLM) is selected from a plurality of LLMs to perform response generation for the one or more utterances received from the customer device based on an execution state of the dialog flow. Further, a plurality of outputs is received from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device. Further, when one or more of the plurality of outputs of the selected one of the plurality of LLMs comprise the one or more entities extracted from the one or more utterances and the response to be transmitted to the customer device, the adherence of: the extracted one or more entities to one or more business rules and the response to one or more conversation rules, are validated. Subsequently, the response of the one or more of the plurality of outputs of the selected one of the plurality of LLMs is transmitted to the customer device when the corresponding validation is successful.

### BRIEF DESCRIPTION OF THE DRAWINGS

FIG. 1A is a block diagram of an exemplary virtual assistant server environment for implementing the concepts and technologies disclosed herein.

FIG. 1B is a block diagram of the virtual assistant platform of the virtual assistant server illustrated in FIG. 1A.

FIG. 1C is a table of exemplary training data that may be used for training a prompt generator illustrated in FIG. 1B.

FIGS. 1D and 1E are tables of exemplary training data that may be used for training a validator illustrated in FIG. 1B.

FIG. 1F is a table of exemplary training data that may be used for training an LLM selector illustrated in FIG. 1B.

FIG. 2 is an example screenshot of a graphical user interface of a virtual assistant builder.

FIG. 3A is a flowchart of an exemplary method for orchestrating a customer conversation by the virtual assistant server of FIG. 1A.

FIG. 3B is a flowchart of an exemplary method for re-prompting a selected LLM post validation failure of an output of the selected LLM.

FIG. 3C is a flow diagram illustrating components of the environment 100 of FIG. 1A that interact with one another to implement the exemplary method of FIG. 3A and FIG. 3B for orchestrating the customer conversation.

FIG. 3D is an example prompt provided to a selected LLM.

FIG. 4 illustrates example validations performed on the outputs of a selected LLM during the customer conversation.

FIG. 5 is an example illustrating validation performed on the output of the selected LLM and re-prompting the selected LLM when the validation fails during the customer conversation.

### DETAILED DESCRIPTION

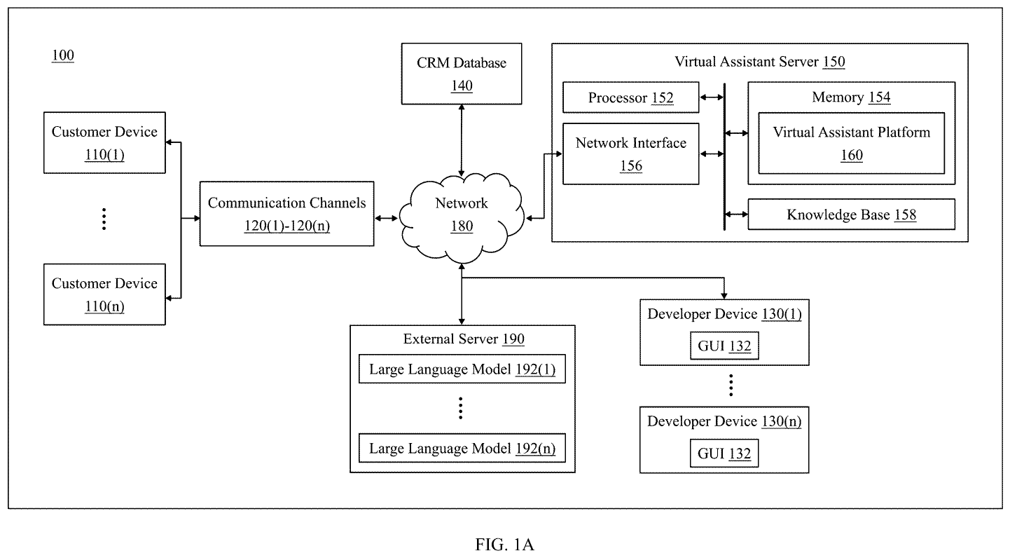

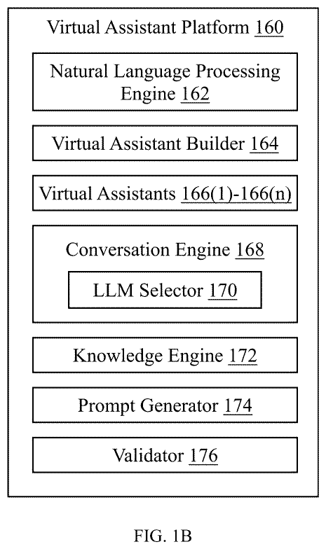

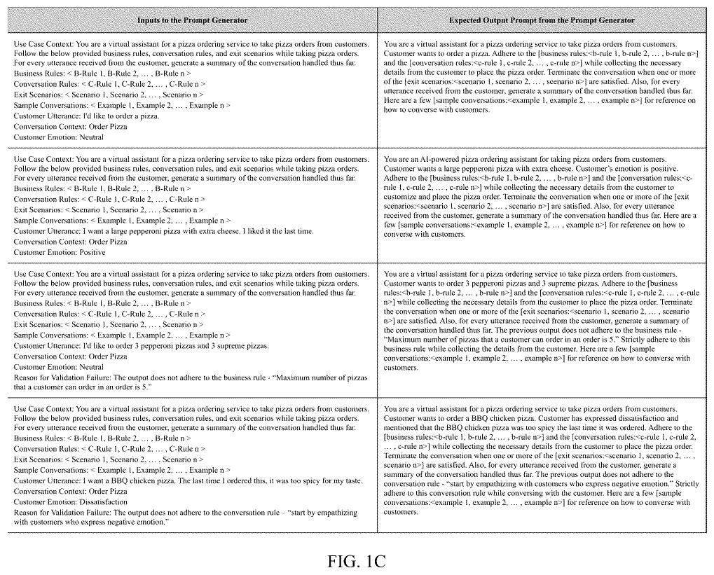

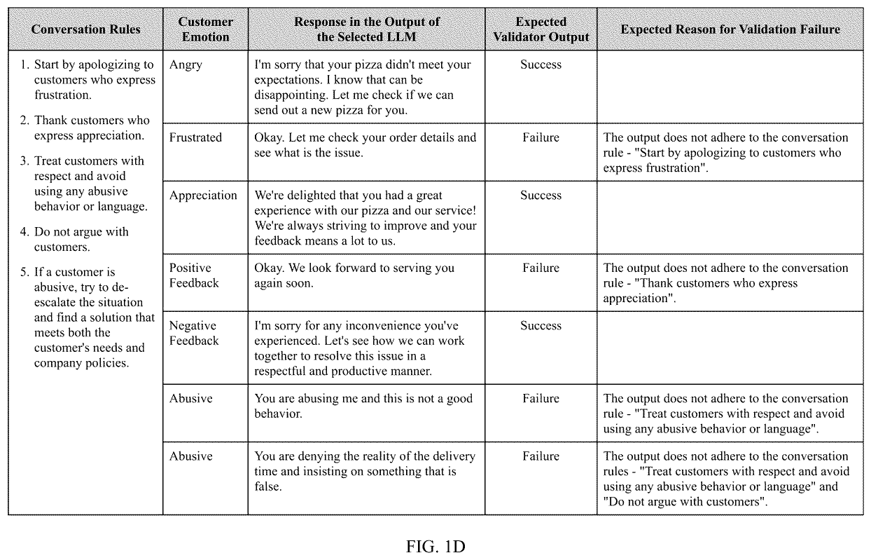

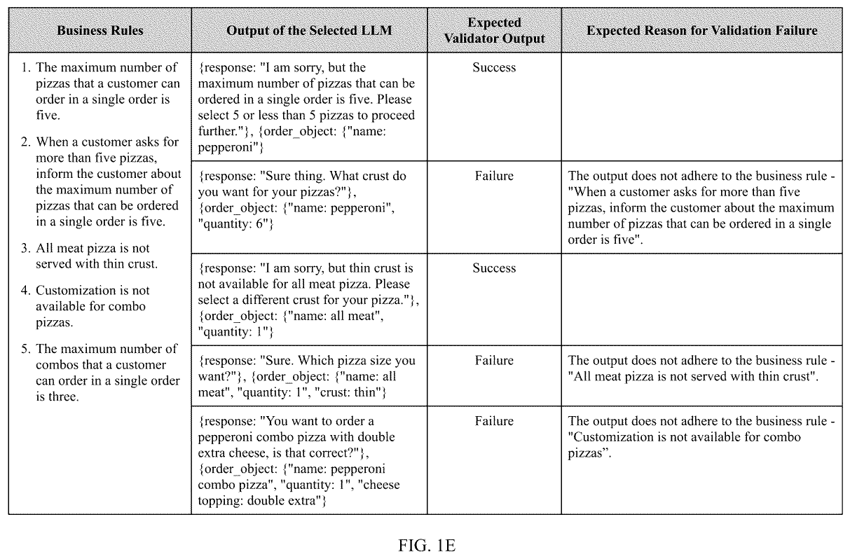

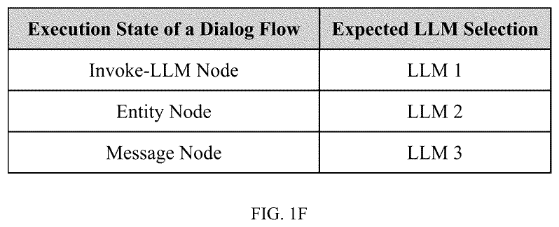

Examples of the present disclosure relate to a virtual assistant server environment 100 (illustrated in FIG. 1A) and, more particularly, to one or more components, systems, computer-readable media and methods for conversation orchestration using a plurality of large language models. The virtual assistant server environment 100 enables developers or administrators of enterprises operating enterprise devices to, by way of example, design, develop, deploy, manage, host, and analyze virtual assistants. Further, the virtual assistant server environment 100 enables developers or administrators of the enterprises operating the enterprise devices to, by way of example, train, optimize and use large language models. A virtual assistant server 150 of the virtual assistant server environment 100 is configured to orchestrate natural language conversations. The one or more developers at one or more enterprise devices may configure, train, optimize and use the virtual assistants and the large language models to converse with customers of the enterprises in natural language.

FIG. 1A is a block diagram of an exemplary virtual assistant server environment 100 for implementing the concepts and technologies disclosed herein. The environment 100 includes: one or more customer devices 110(1)-110(n), a plurality of communication channels 120(1)-120(n), a one or more developer devices 130(1)-130(n), a customer relationship management (CRM) database 140, a virtual assistant server 150, and an external server 190, all coupled together via a network 180, although the environment 100 can include other types and numbers of systems, devices, components, and/or elements and in other topologies and deployments. Although not illustrated, the environment 100 may include additional network components, such as routers, switches, and other devices, which are well known to those of ordinary skill in the art and thus will not be described here.

The one or more customer devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more customer devices 110(1)-110(n) may have other types and/or numbers of other systems, devices, components, and/or other elements. The customers accessing the one or more customer devices 110(1)-110(n) provide inputs (e.g., in text or voice) to the virtual assistant server 150. The virtual assistant server 150 provides responses to the inputs. In one example, the virtual assistant server 150 communicates with the external server 190 to provide responses to the inputs.

The one or more developer devices 130(1)-130(n) may communicate with the virtual assistant server 150 and/or the external server 190 via the network 180. The one or more developers at the one or more developer devices 130(1)-130(n) may access and interact with the functionalities exposed by the virtual assistant server 150 and/or the external server 190 via the one or more developer devices 130(1)-130(n). The one or more developer devices 130(1)-130(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 130(1)-130(n) may include software and hardware capable of communicating with the virtual assistant server 150 and/or the external server 190 via the network 180. Also, the one or more developer devices 130(1)-130(n) may comprise a graphical user interface (GUI) 132 to render and display the information received from the virtual assistant server 150 and/or the external server 190. The one or more developer devices 130(1)-130(n) may communicate with and the virtual assistant server 150 and/or the external server 190 via one or more application programming interfaces (APIs) or one or more hyperlinks exposed by the virtual assistant server 150 and/or the external server 190 respectively, although other types and/or numbers of communication methods may be used in other configurations.

The one or more developer devices 130(1)-130(n) may run applications, such as web browsers or virtual assistant software, which may render the GUI 132, although other types and/or numbers of applications may render the GUI 132 in other configurations. In one example, the one or more developers at the one or more developer devices 130(1)-130(n) may, by way of example, make selections, provide inputs using the GUI 132 or interact, by way of example, with data, icons, widgets, or other components displayed in the GUI 132.

The CRM database 140 may store the customers information comprising at least one of profile details (e.g., name, address, phone numbers, gender, age, and occupation), communication channel preferences (e.g., text chat, SMS, voice chat, multimedia chat, social networking chat, web, and telephone call), language preferences, membership information (e.g., membership ID, and membership category), transaction data (e.g., communication session details such as: date, time, or the like), and past interactions data (such as sentiment, feedback, service ratings, or the like), although the CRM database 140 may store other types and numbers of customer information in other configurations. The CRM database 140 may be updated dynamically or periodically based on the customer conversations with the virtual assistant server 150. Although depicted as an external component in FIG. 1A, in one example, the CRM database 140 may be hosted and/or managed by the virtual assistant server 150.

The network 180 enables the one or more customer devices 110(1)-110(n), the one or more developer devices 130(1)-130(n), the CRM database 140, or other such devices to communicate with the virtual assistant server 150. The network 180 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although the network 180 may include other types and/or numbers of networks in other topologies or configurations.

The network 180 may support protocols such as, Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Description Protocol (SDP), Web Real-Time Communication (WebRTC), Transmission Control Protocol/Internet Protocol (TCP/IP), User Datagram Protocol (UDP), or Voice over Internet Protocol (VOIP), although other types and/or numbers of protocols may be supported in other topologies or configurations. The network 180 may also support standards or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. The network interface 156 of the virtual assistant server 150 may include any interface that is suitable to connect with any of the above-mentioned network types and communicate using any of the above-mentioned network protocols, standards, or formats.

The external server 190 may host and/or manage a plurality of large language models (LLMs) 192(1)-192(n). In one example, the plurality of LLMs 192(1)-192(n) may be pre-trained general purpose LLMs (e.g., ChatGPT) or fine-tuned LLMs for an enterprise or one or more domains. The external server 190 may create, host, and/or manage the plurality LLMs 192(1)-192(n) based on training provided by the one or more developers using the one or more developer devices 130(1)-130(n). The external server 190 may be a cloud-based server or an on-premises server. The plurality LLMs 192(1)-192(n) may be accessed using application programming interfaces (APIs) for use in applications. In another example, the plurality of LLMs 192(1)-192(n) may be hosted by the external server 190 and managed remotely by the virtual assistant server 150. In another example, the plurality of LLMs 192(1)-192(n) may be hosted and/or managed by the virtual assistant server 150.

An LLM is a type of artificial intelligence-machine learning (AI/ML) model that is used to process natural language data for tasks such as natural language processing, text mining, text classification, machine translation, question-answering, response generation, or the like. The LLM uses deep learning or neural networks to learn language features from large amounts of data. The LLM is, for example, trained on a large dataset and then used to generate predictions or generate features from unseen data. The LLM can be used to generate language features such as word embeddings, part-of-speech tags, named entity recognition, sentiment analysis, or the like. Unlike traditional rule-based NLP systems, the LLM does not rely on pre-defined rules or templates to generate responses. Instead, the LLM uses a probabilistic approach to language generation, where the LLM calculates the probability of each word in a response based on the patterns the LLM learned from the training data.

The virtual assistant server 150 includes a processor 152, a memory 154, a network interface 156, and a knowledge base 158, although the virtual assistant server 150 may include other types and/or numbers of components in other configurations. In addition, the virtual assistant server 150 may include an operating system (not shown). In one example, the virtual assistant server 150, one or more components of the virtual assistant server 150, and/or one or more processes performed by the virtual assistant server 150 may be implemented using a networking environment (e.g., cloud computing environment). In one example, the capabilities of the virtual assistant server 150 may be offered as a service using the cloud computing environment.

The components of the virtual assistant server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although other types and/or numbers of buses may be used in other configurations.

The processor 152 of the virtual assistant server 150 may execute one or more computer-executable instructions stored in the memory 154 for the methods illustrated and described with reference to the examples herein, although the processor 152 may execute other types and numbers of instructions and perform other types and numbers of operations. The processor 152 may comprise one or more central processing units (CPUs), or general-purpose processors with a plurality of processing cores, such as Intel® processor(s), AMD® processor(s), although other types of processor(s) could be used in other configurations. Although the virtual assistant server 150 may comprise multiple processors, only a single processor (i.e., the processor 152) is illustrated in FIG. 1A for simplicity.

The memory 154 of the virtual assistant server 150 is an example of a non-transitory computer readable storage medium capable of storing information or instructions for the processor 152 to operate on. The instructions, which when executed by the processor 152, perform one or more of the disclosed examples. In one example, the memory 154 may be a random access memory (RAM), a dynamic random access memory (DRAM), a static random access memory (SRAM), a persistent memory (PMEM), a nonvolatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, or a combination of two or more of these. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1A, the memory 154 may include instructions corresponding to a virtual assistant platform 160 of the virtual assistant server 150, although other types and/or numbers of instructions in the form of programs, functions, methods, procedures, definitions, subroutines, or modules may be stored. The memory 154 may also include data structures storing information corresponding to the virtual assistant platform 160. The virtual assistant server 150 receives communications from one or more customers at the one or more customer devices 110(1)-110(n) and/or one or more developers at the one or more developer devices 130(1)-130(n) and uses the virtual assistant platform 160 to provide responses to the received communications.

The network interface 156 may include hardware, software, or a combination of hardware and software, enabling the virtual assistant server 150 to communicate with the components illustrated in the environment 100, although the network interface 156 may enable communication with other types and/or number of components in other configurations. In one example, the network interface 156 provides interfaces between the virtual assistant server 150 and the network 180. The network interface 156 may support wired or wireless communication. In one example, the network interface 156 may include an Ethernet adapter or a wireless network adapter to communicate with the network 180.

The customers at the one or more customer devices 110(1)-110(n) may access and interact with the functionalities exposed by the virtual assistant server 150 via the network 180. The one or more customer devices 110(1)-110(n) may include any type of computing device that can facilitate customer interaction, for example, a desktop computer, a laptop computer, a tablet computer, a smartphone, a mobile phone, a wearable computing device, or any other type of device with communication and data exchange capabilities. The one or more customer devices 110(1)-110(n) may include software and hardware capable of communicating with the virtual assistant server 150 via the network 180. Also, the one or more customer devices 110(1)-110(n) may render and display the information received from the virtual assistant server 150. The one or more customer devices 110(1)-110(n) may render an interface of the one or more communication channels 120(1)-120(n) which the customers may use to interact with the virtual assistant server 150.

The customers at the one or more customer devices 110(1)-110(n) may interact with the virtual assistant server 150 via the network 180 by providing text utterance, voice utterance, or a combination of text and voice utterances via the one or more communication channels 120(1)-120(n). The one or more communication channels 120(1)-120(n) may include channels such as, enterprise messengers (e.g., Skype for Business, Microsoft Teams, Kore.ai Messenger, Slack, Google Hangouts, or the like), social messengers (e.g., Facebook Messenger, WhatsApp Business Messaging, Twitter, Lines, Telegram, or the like), web & mobile channels (e.g., a web application, a mobile application), interactive voice response (IVR) channels, voice channels (e.g., Google Assistant, Amazon Alexa, or the like), live chat channels (e.g., LivePerson, LiveChat, Zendesk Chat, Zoho Desk, or the like), a webhook channel, a short messaging service (SMS), email, a software-as-a-service (SaaS) application, voice over internet protocol (VOIP) calls, computer telephony calls, or the like. It may be understood that to support voice-based communication channels, the environment 100 may include, for example, a public switched telephone network (PSTN), a voice server, a text-to-speech (TTS) engine, and/or an automatic speech recognition (ASR) engine.

The knowledge base 158 of the virtual assistant server 150 may comprise one or more enterprise-specific databases that may comprise enterprise information such as, for example, products and services, business rules, and/or conversation rules, in the form of, for example, frequently asked questions (FAQs), online content (e.g., articles, books, magazines, PDFs, web pages, product menu, services menu), audio-video data, or graphical data that may be organized as relational data, tabular data, knowledge graph, or the like. The knowledge base 158 may be accessed by the virtual assistant platform 160 while handling customer conversations. The developers at the one or more developer devices 130(1)-130(n) may search the knowledge base 158, for example, using the GUI 132, although other manners for interacting with the knowledge base 158 may be used. The knowledge base 158 may be dynamically updated. The knowledge base 158 may comprise a number of different databases, some of which may be internal or external to the virtual assistant server 150. Although there may be multiple databases, a single knowledge base 158 is illustrated in FIG. 1A for simplicity.

FIG. 1B is a block diagram of the virtual assistant platform 160 of the virtual assistant server 150 illustrated in FIG. 1A. As illustrated in FIG. 1B, the virtual assistant platform 160 comprises instructions or data corresponding to a natural language processing (NLP) engine 162, a virtual assistant builder 164, one or more virtual assistants 166(1)-166(n), a conversation engine 168, a knowledge engine 172, a prompt generator 174, and a validator 176, although other types and/or numbers of instructions or data in the form of programs, functions, methods, procedures, definitions, subroutines, modules, or structured or unstructured text, may be stored on the virtual assistant platform 160. Examples of the steps or functions performed when the programmed instructions stored in the memory 154 are executed are illustrated and described by way of the figures and description associated with the examples herein.

The NLP engine 162 performs natural language understanding and natural language generation tasks. The NLP engine 162 may incorporate technologies or capabilities such as machine learning, semantic rules, component relationships, neural networks, rule-based engines, or the like. The NLP engine 162 interprets one or more customer utterances received from the one or more customer devices 110(1)-110(n), to identify one or more use cases of the one or more customer utterances or one or more entities in the one or more customer utterances and generates one or more responses to the one or more customer utterances. The use case of a customer utterance is a textual representation of what the customer wants the virtual assistant to do. The one or more entities in the customer utterance are, for example, parameters, fields, data, or words required by the virtual assistant to fulfill the use case. For example, in the customer utterance-“Book me a flight to Orlando for next Sunday,” the use case is “Book Flight”, and the entities are “Orlando” and “Sunday.”

The NLP engine 162 also creates and executes language models corresponding to the one or more virtual assistants 166(1)-166(n). In one example, the language models classify the one or more customer utterances into one or more use cases configured for the one or more virtual assistants 166(1)-166(n) based on the configuration and/or training added to the one or more virtual assistants 166(1)-166(n) using the virtual assistant builder 164, although other types and/or numbers of functions may be performed by the language models in other configurations. Also, the NLP engine 162 may use one or more pre-defined and/or custom-trained language models. The language models may be machine learning models, rule-based models, predictive models, neural network based models, semantic models, component relationship based models, large language models, or artificial intelligence based models, although there may be other types and/or numbers of language models in other configurations. In one example, the virtual assistant server 150 may determine, based on a configuration, when to use the language models created by the NLP engine 162 and when to use the LLMs created, hosted, and/or managed by the virtual assistant server 150 or the external server 190.

The virtual assistant builder 164 of the virtual assistant platform 160 may be served from and/or hosted on the virtual assistant server 150 and may be accessible as a website, a web application, or a software-as-a-service (SaaS) application. Enterprise users, such as a developer or a business analyst by way of example, may access the functionality of the virtual assistant builder 164, for example, using web requests, API requests, although the functionality of the virtual assistant builder 164 may be accessed using other types and/or numbers of methods in other configurations. The one or more developers at the one or more developer devices 130(1)-130(n) may design, create, configure, and/or train the one or more virtual assistants 166(1)-166(n) using the GUI 132 provided by the virtual assistant builder 1642. In one example, the functionality of the virtual assistant builder 164 may be exposed as the GUI 132 rendered in a web page in the web browser accessible using the one or more developer devices 130(1)-130(n), such as a desktop or a laptop by way of example. The one or more developers at the one or more developer devices 130(1)-130(n) may interact with user interface (UI) components, such as windows, tabs, widgets, or icons of the GUI 132 rendered in the one or more developer devices 130(1)-130(n) to create, train, deploy, manage and/or optimize the one or more virtual assistants 166(1)-166(n). The virtual assistant builder 164 described herein can be integrated with different application platforms, such as development platforms or development tools or components thereof already existing in the marketplace, e.g., Facebook® Messenger, Microsoft® Bot Framework, third-party LLM platforms such as Open AI through APIs by way of example.

After the one or more virtual assistants 166(1)-166(n) are deployed, the customers of the enterprise may communicate with the one or more virtual assistants 166(1)-166(n) to, for example, purchase products, raise complaints, access services provided by the enterprise, or to know information about the services offered by the enterprise. Each virtual assistant of the one or more virtual assistants 166(1)-166(n) may be configured with one or more use cases for handling customer utterances and each of the one or more use cases may be further defined using a dialog flow. In one example, each of the one or more virtual assistants 166(1)-166(n) may be configured using other methods, such as software code in other configurations. A dialog flow may refer to the sequence of interactions between the customer and a virtual assistant in a conversation. In one example, the dialog flow of a use case of the virtual assistant comprises a series of interconnected nodes, for example, an intent node, one or more entity nodes, one or more invoke LLM nodes, one or more service nodes, one or more confirmation nodes, one or more message nodes, or the like, that define steps to be executed to fulfil the use case. The nodes of the dialog flow may include various types of interactions, such as, for example, questions, prompts, confirmations, and messages, and are configured to gather information from the customer, provide information to the customer, or perform a specific action. Each node of the dialog flow represents a specific point in the conversation and edges between the nodes represent possible paths that the conversation can take.

For each of the one or more virtual assistants 166(1)-166(n), the developer using the virtual assistant platform 160 may provide training data such as: use case labels, out-of-domain use case labels, one or more utterances corresponding to each use case label, business rules, domain knowledge, description of one or more entities, conversation rules comprising: flow rules, digression rules, or the like. The developer may provide training data in the form of text, structured text, code, or the like.

The conversation engine 168 orchestrates the conversations between the one or more customer devices 110(1)-110(n) and the virtual assistant server 150 by executing the one or more virtual assistants 166(1)-166(n) that are configured by the one or more developers at the one or more developer devices 130(1)-130(n). Further, the conversation engine 168 may be responsible for orchestrating a customer conversation by communicating with various components of the virtual assistant server 150 to perform various actions (e.g., understanding the customer utterance, identify an intent, retrieving relevant data, generating a response, transmitting the response to the customer, or the like) and routing data between the components of the virtual assistant server 150. For example, the conversation engine 168 may communicate with the NLP engine 162, the LLMs 192(1)-192(n) hosted and managed by the external server 190, or other components of the virtual assistant server 150 to orchestrate conversations with the customers at the one or more customer devices 110(1)-110(n). Further, the conversation engine 168 may perform state management of each conversation managed by the virtual assistant server 150. In one example, the conversation engine 168 may be implemented as a finite state machine that uses states and state information to orchestrate conversations between the one or more customer devices 110(1)-110(n) and the virtual assistant server 150. The conversation engine 168 may also manage the context of a conversation between the one or more customer devices 110(1)-110(n) and the one or more virtual assistants 166(1)-166(n) managed and hosted by the virtual assistant server 150. Further, the conversation engine 168 may manage digressions or interruptions provided by the customers at the one or more customer devices 110(1)-110(n) during the conversations with the one or more virtual assistants 166(1)-166(n). In one example, the conversation engine 168 and the NLP engine 162 may be configured as a single component.

The conversation engine 168 may comprise an LLM selector 170, as illustrated in FIG. 1B. In one example, the LLM selector 170 may be implemented as a rule-based model. The conversation engine 168, with the help of the LLM selector 170 may select one of the plurality of LLMs 192(1)-192(n) based on at least one of: an execution state of a dialog flow that is executed, the conversation context, or one or more execution goals of the dialog flow of a use case that is executed. In one example, when building the dialog flow of the use case, a developer at a developer device 130(1) may pre-configure LLM selection in one or more nodes of the dialog flow of the use case or in NLP settings or natural language understanding (NLU) settings of the virtual assistant 166(1), based on which the LLM selector 170 may select one of the plurality of LLMs 192(1)-192(n) based on the execution state when the dialog flow is executed. In another example, the developer at the developer device 130(1) may configure rules for the rule-based LLM selector 170, where the rules define which one of the plurality of LLMs 192(1)-192(n) to be selected by the rule-based LLM selector 170 when the execution state of the dialog flow reaches one or more nodes when the dialog flow is executed, as illustrated in FIG. 1F. Although not illustrated in FIG. 1F, the rules configured for the rule-based LLM selector 170 may comprise other types and/or numbers of rules in different configurations.

The conversation context may be defined as a memory of the conversation comprising message turns between the customer at a customer device 110(1) and a virtual assistant 166(1). In one example, the conversation context may comprise information such as the use case identified, one or more entities extracted from one or more customer utterances, conversation transcript, or the like. The conversation context is tracked and maintained by the conversation engine 168. In one example, the conversation context is used to determine the meaning of each message data that is a part of the conversation. The execution state of the dialog flow may be defined as a currently executed node (e.g., entity node, confirmation node, message node, invoke-LLM node, service node) during the conversation between the customer at the customer device 110(1) and the virtual assistant 166(1). In one example, if the virtual assistant server 150 is generating a response to the customer, the execution state of the dialog flow is said to reach one of the one or more message nodes of the dialog flow.

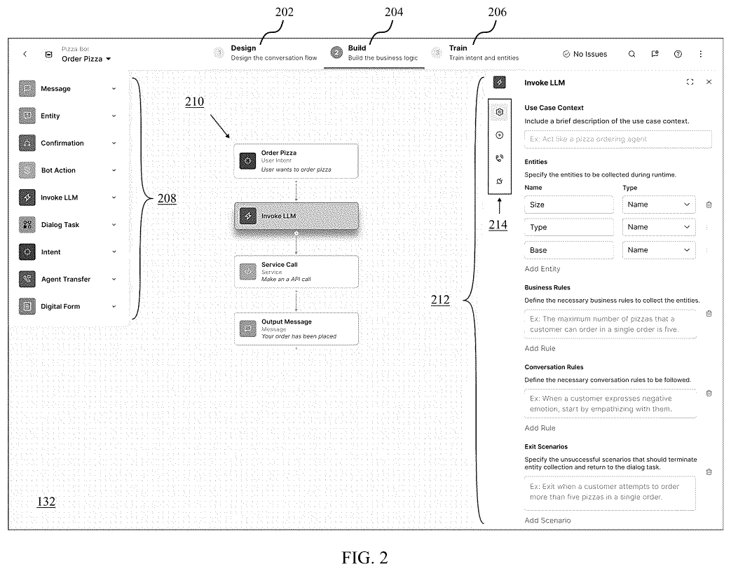

An execution goal of the dialog flow may be defined as a successful outcome for the conversation which may comprise, for example, determining a use case of the customer utterance, collecting information from the customer to fulfill the use case, making a service call to one or more data sources to retrieve information to be provided to the customer, providing a response to the customer, summarizing information to be provided to the customer, or the like. An invoke-LLM node in the dialog flow of the use case of the virtual assistant may be defined as the node at which one of the plurality of LLMs 192(1)-192(n) is invoked to complete the one or more execution goals of the dialog flow. In one example, each dialog flow of the use case may comprise one or more invoke-LLM nodes and each of the one or more invoke-LLM nodes may invoke the same LLM or a different LLM based on the execution goal determined. The details and configuration of the invoke-LLM node are further described in detail below with reference to FIG. 2.

For example, when execution of a dialog flow corresponding to a use case—“Book Flight” is initiated and when the execution reaches the invoke-LLM node, based on the LLM selection pre-configured by the developer in the invoke-LLM node of the dialog flow corresponding to the “Book Flight” use case, the LLM selector 170 selects one of the plurality of LLMs 192(1)-192(n) that collects entity information such as, for example, source city, destination city, date of travel, number of passengers, travel class, or the like from the customer. In this example, when the LLM selector 170 selects one of the plurality of LLMs 192(1)-192(n), the virtual assistant server 150 with the help of the prompt generator 174 provides a prompt comprising information such as, for example, use case context, one or more execution goals, the conversation context, customer context, customer sentiment, one or more business rules, one or more conversation rules, one or more exit scenarios, a few-shot sample conversations, and an output format to the selected LLM that collects the required information from the customer to book a flight. Upon collecting the required information from the customer, the selected LLM sends the collected information to the virtual assistant server 150. Further, the execution of the dialog flow of the use case-“Book Flight” reaches a service node, where an API call may be placed to a data source, for example, a travel website to fetch a list of available flights based on the information collected by the selected LLM from the customer. Upon fetching the list of available flights, the execution of the dialog flow of the use case-“Book Flight” reaches a message node, where the list of available flights may be sent to the customer. In one example, for generating the response to be sent to the customer, the conversation engine 168, using the LLM selector 170 may select one of the plurality of LLMs 192(1)-192(n) for generating the response to be sent to the customer.

The knowledge engine 172 is designed and configured to manage and retrieve structured and unstructured data stored in the knowledge base 158 or any other enterprise related data sources such as enterprise's ticketing system, CRM database 140, or the like. The knowledge engine 172 may use advanced algorithms and NLP techniques to understand the meaning and context of data and to retrieve relevant information from the knowledge base 158 or any other enterprise related data sources or databases for the customer utterance. In one example, the knowledge engine 172 may be implemented as an AI/ML model, where the model may be trained on the enterprise data such as, product menus, products and services descriptions, business rules, policy documents, enterprise's social media data, or the like.

The prompt generator 174 may be an artificial intelligence-machine learning (AI-ML) model that generates one or more prompts in text form for the selected LLM to generate a required output. A prompt may be defined as one or more instructions provided to the LLM in the form of one or more sentences, one or more phrases, or a single word that provides a context or a theme for the selected LLM to generate a required output. The prompt generator 174 may generate the one or more text prompts for the selected LLM based on the information provided by the conversation engine 168 such as, for example, use case context, customer utterance, transcript of the conversation between the customer at the customer device 110(1) and the virtual assistant server 150, the conversation context, one or more business rules, one or more conversation rules, customer context, one or more exit scenarios, a few-shot sample conversations, customer emotion data retrieved by the knowledge engine 172, a reason for validation failure, and required output format, although the conversation engine 168 may provide any other information to the prompt generator 174 based on the use case. Using the prompt generator 174 in conjunction with the conversation engine 168 can help the virtual assistant server 150 to manage conversations and generate relevant responses from the selected LLM for complex use cases in a fluent and efficient manner, improving the overall conversational experience for the customers.

In one example, the prompt generator 174 may be trained on a dataset of input-output pairs (as illustrated in FIG. 1C). FIG. 1C is a table of exemplary training data that may be used for training the prompt generator 174. As illustrated in FIG. 1C, the input in the training data to the prompt generator 174 may comprise, for example, the use case context, the customer utterance, the conversation context, the one or more business rules, the one or more conversation rules, the one or more exit scenarios, the reason for validation failure, few-shot sample conversations, and the customer emotion. Further, as illustrated in FIG. 1C, the output in the training data to the prompt generator 174 comprises an expected output prompt from the prompt generator 174. Although not illustrated in FIG. 1C, other types and/or numbers of input-output pairs may be used in other configurations to train the prompt generator 174. The prompt generator 174 uses this training data to learn patterns and relationships between the inputs and the outputs and generates relevant prompts based on the learned patterns and relationships. In another example, for a given use case, the developer at the developer device 130(1) may pre-configure one or more prompt templates for each of the plurality of LLMs 192(1)-192(n) and the prompt generator 174 may use one of the one or more prompt templates to provide one or more prompts to the selected LLM. A prompt template may comprise data such as for example, one or more instructions, and/or placeholders that indicate where the static inputs (e.g., the use case context, the one or more business rules, the one or more conversation rules, the one or more exit scenarios, and the few-shot sample conversations) and the dynamic inputs (e.g., the customer utterance, the customer context, the conversation context, the customer emotion, the reason for validation failure, or the like) should be placed.

### Definitions

The customer utterance may be defined as an input provided by the customer at the customer device 110(1) during the conversation with the virtual assistant 166(1). For example, if the customer inputs “Book me a flight to Orlando for next Sunday”, the entire sentence is considered as the customer's utterance.

The conversation context may be defined as a memory of the conversation comprising message turns between the customer at the customer device 110(1) and the virtual assistant 166(1). The conversation context may comprise, for example, the identified use case from one or more customer utterances, one or more identified entities from the one or more customer utterances, identified language, or any other information based on the use case.

The customer context comprises information about the customer interacting with the virtual assistant 166(1). The information about the customer may include details such as, for example, the customer's preferences, past interactions of the customer with the virtual assistant server 150, customer's account information, and any other information that helps the virtual assistant server 150 to personalize the conversation and provide tailored assistance to the customer.

The use case context may comprise a brief description of the use case that the selected LLM 192(1) is used to handle.

The one or more business rules of an enterprise are predefined guidelines that dictate how the selected LLM should behave or respond while fulfilling the one or more execution goals.

The one or more conversation rules are predefined guidelines defined by the enterprise that define how the selected LLM should handle different types of customer utterances, customer emotions, or the like and generate appropriate responses.

The few-shot sample conversations are a set of example conversations that guide the selected LLM on how to handle different types of customer utterances, virtual assistant responses, overall flow of the conversation to the intended use case, or the like. The selected LLM may learn patterns and gain a better understanding of the desired conversational behavior from the few-shot sample conversations.

Referring back to FIG. 1B, the validator 176 is a component of the virtual assistant platform 160 responsible for checking the validity and quality of the output generated by the selected LLM before sending the output to the customer. For example, the validator 176 may perform various checks on the selected LLM output to ensure that the selected LLM output meets validation requirements, such as satisfying the one or more business rules, satisfying the one or more conversation rules, the one or more exit scenarios, or the like. In one example, the validator 176 may use the one or more business rules, the one or more conversation rules, and the one or more exit scenarios that are stored in the knowledge base 158 to validate the selected LLM output. In another example, the one or more business rules, the one or more conversation rules, and the one or more exit scenarios may be stored and managed by the validator 176. Further, when the selected LLM output fails the validation, the validator 176 may generate and provide a reason for the validation failure to the conversation engine 168. Based on the validation result provided by the validator 176, the conversation engine 168 may: send the selected LLM output to the customer; or use the prompt generator 174 to re-prompt the selected LLM such that the selected LLM generates the output that meets the validation requirements.

In one example, the validator 176 may be implemented as a rule-based model, where the validator 176 is trained on a set of predefined rules such as, the one or more business rules, the one or more conversation rules, and the output format that define the requirements of a valid output of the selected LLM. In another example, the validator 176 may be implemented as an ML model which is trained on labeled LLM outputs.

FIGS. 1D and 1E are tables of exemplary training data that may be used for training the validator 176. As illustrated in FIG. 1D, the validator 176 is trained on the training data comprising the one or more conversation rules, customer emotion, a response in the selected LLM output, expected output of the validator 176, and an expected reason for validation failure. As illustrated in FIG. 1E, the validator 176 is trained on the training data comprising the one or more business rules, the selected LLM output, expected output of the validator 176, and an expected reason for validation failure. Although not illustrated in 1D and 1E, other types and/or numbers of training data may be used in other configurations to train the validator 176.

In this example, the validator 176 may be initially trained on the one or more conversation rules and the one or more business rules, where the validator 176 learns the patterns present in the one or more conversation rules and the one or more business rules. Upon training the validator 176 with the one or more conversation rules and the one or more business rules, the validator 176 may be further trained on the labeled training data illustrated in FIGS. 1D and 1E such that the validator 176 can efficiently validate the selected LLM outputs.

FIG. 2 is an example screenshot of the GUI 132 of the virtual assistant builder 164 displayed, for example, in the developer device 130(1). The developer device 130(1) may display the example screenshot of the GUI 132 of the virtual assistant builder 164 based on instructions or information received from the virtual assistant server 150. In this example, the GUI 132 displays a pizza virtual assistant created using the GUI 132 of the virtual assistant builder 164, although other types and/or numbers of information may be displayed in the GUI 132 of the virtual assistant builder 164 in other configurations. The GUI 132 of the virtual assistant builder 164 comprises multiple tabs such as design 202, build 204, and train 206, although the GUI 132 of the virtual assistant builder 164 may comprise other types and/or numbers of tabs in other configurations. The tabs 202, 204, and 206 display different phases involved in creating the virtual assistant (in this example, the pizza virtual assistant) such as design phase, build phase, and train phase.

In the design 202 tab, the developer at the developer device 130(1) can design one or more sample conversations or expected conversation paths between the customer and the pizza virtual assistant for the “Order Pizza” use case by defining utterances of the customer and responses of the pizza virtual assistant.

The build 204 tab comprises a node panel 208 containing a plurality of node types (e.g., message node, entity node, bot action node, invoke-LLM node, agent transfer node) that the developer at the developer device 130(1) can use to create the dialog flow of the use case of the virtual assistant. In this example, the developer at the developer device 130(1) can use one or more of the plurality of node types from the node panel 208 to create a dialog flow 210 of the “Order Pizza” use case of the pizza virtual assistant via drag-and-drop mechanism or click to add mechanism. The dialog flow 210 of the “Order Pizza” use case comprises a plurality of nodes: an intent node, an invoke-LLM node, a service node, and a message node, although the dialog flow 210 may comprise other types and/or numbers of nodes in other configurations. Further, when a node in the dialog flow 210 is selected (the invoke-LLM node in this example), a properties panel 212 corresponding to the selected node is displayed in the GUI 132. In one example, the node that is selected in the dialog flow 210 may be highlighted in a color (as illustrated in FIG. 2), although other mechanisms such as popping-out, drop-in shadow, colored border, or the like may be used to highlight the node that is selected.

Further, based on the type of the node that is selected in the dialog flow 210, the properties panel 212 displays one or more of a plurality of settings 214 (such as general settings, instance settings, NLP settings, voice call settings, and connection settings) that the developer at the developer device 130(1) can use to configure the node by defining different properties. Further, based on the type of the node that is selected, different types and/or numbers of properties may be displayed in each of the plurality of settings 214 that the developer at the developer device 130(1) may define to configure the node. In this example, the developer at the developer device 130(1) may configure general settings of the invoke-LLM node by defining one or more properties such as the use case context, one or more entities to be collected by the selected LLM from the customer, the one or more business rules to be followed by the selected LLM while collecting the one or more entities, the one or more conversation rules to be followed by the selected LLM, and the one or more exit scenarios to be considered by the selected LLM to terminate entity collection. Subsequently, the developer at the developer device 130(1) may define other properties in each of the plurality of settings 214 displayed in the properties panel 212 to configure the information provided to the selected LLM or to request information from the selected LLM in one or more predefined formats.

In the train 206 tab, the developer at the developer device 130(1) may add training data such as utterances, patterns, traits, and rules to train the virtual assistant (the pizza virtual assistant, in this example) for the dialog flow 210 built in the build 204 tab. In one example, the developer at the developer device 130(1) may add the training data when designing the conversation in the design 202 tab. The training data helps the virtual assistant server 150 to identify the use case and trigger the execution of the dialog flow corresponding to the identified use case. In one example, the virtual assistant server 150 creates or fine-tunes a use case detection model based on the training provided by the developer at the developer device 130(1).

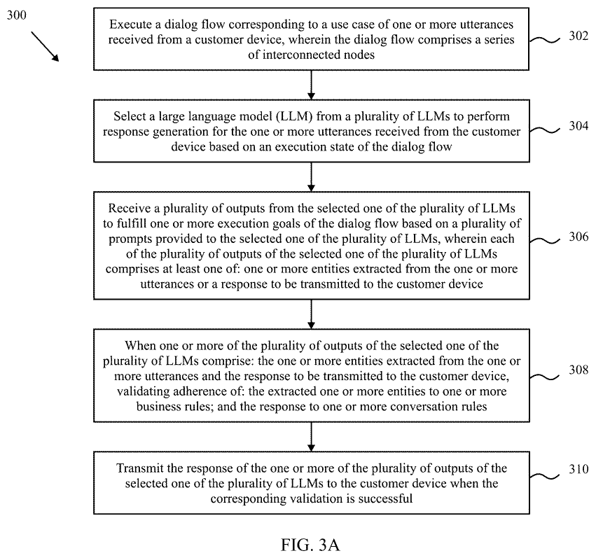

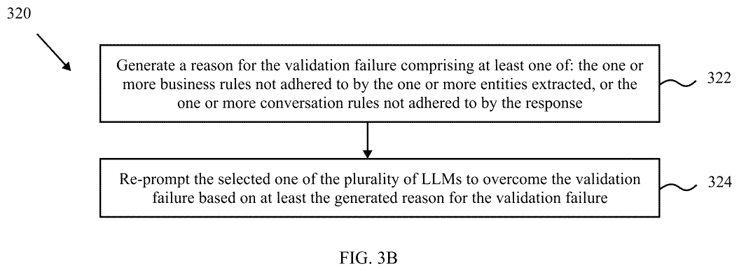

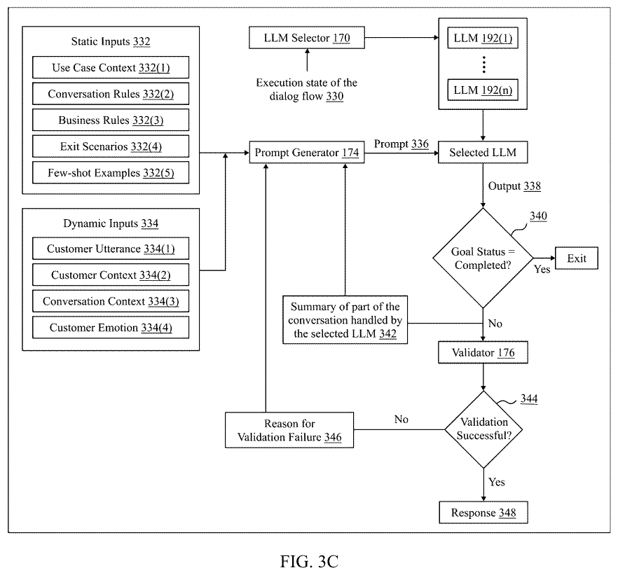

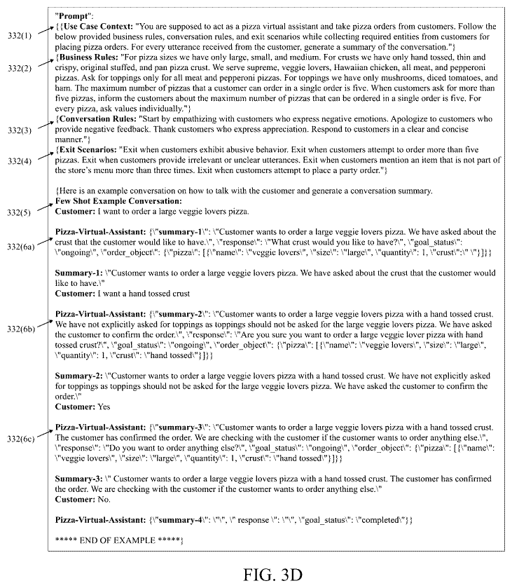

FIG. 3A is a flowchart of an exemplary method 300 for orchestrating a customer conversation by the virtual assistant server 150 of FIG. 1A. The exemplary method 300 may be performed by the system components illustrated in the environment 100 of FIG. 1A. The exemplary method 300 may be performed by the virtual assistant server 150 during a conversation between the customer at the customer device 110(1) and the virtual assistant 166(1) (the pizza virtual assistant, in this example) hosted and/or managed by the virtual assistant server 150. The virtual assistant server 150 may interact with other components of the environment 100 to perform the steps of the exemplary method 300. In FIG. 3A, the ordering of steps of the method 300 is exemplary and any other ordering of the steps may be possible, not all the steps may be required, and in some implementations, some steps may be omitted, or other steps may be added.

At step 302, the virtual assistant server 150, executes a dialog flow corresponding to a use case of one or more customer utterances received from the customer device 110(1) to provide one or more responses to the one or more customer utterances. The one or more customer utterances received from the customer device 110(1) may be at least one of: text-based utterances, voice-based utterances, or a combination of text-based and voice-based utterances. In this example, the customer at the customer device 110(1) may interact with the pizza virtual assistant 166(1) by providing a customer utterance-“I want to order a pizza”. In one example, the NLP engine 162 of the virtual assistant server 150, processes the customer utterance-“I want to order a pizza” and identifies the use case of the customer utterance as “Order Pizza”. In another example, the virtual assistant server 150 may select one of the plurality of LLMs 192(1)-192(n) that is configured to process the customer utterance and identify the use case of the customer utterance. Further, the virtual assistant server 150 using the conversation engine 168, may execute the dialog flow 210 (illustrated in FIG. 2) corresponding to the identified “Order Pizza” use case of the pizza virtual assistant 166(1) to provide the one or more responses to the customer at the customer device 110(1).

At step 304, the virtual assistant server 150, using the LLM selector 170, selects one of the plurality of LLMs 192(1)-192(n) based on a current execution state of the dialog flow to perform response generation for the one or more customer utterances received from the customer device 110(1). In one example, the execution state of the dialog flow 210 may be defined as a current one of the series of interconnected nodes of the dialog flow 210 that is currently being executed during the conversation between the customer at the customer device 110(1) and the pizza virtual assistant 166(1). Hereinafter, the LLM selected by the LLM selector 170 is referred to as the selected LLM 192(1).

At step 306, the virtual assistant server 150, using the prompt generator 174 provides a plurality of prompts to the selected LLM 192(1) to fulfill one or more execution goals and receive a plurality of outputs to the plurality of prompts from the selected LLM 192(1) when fulfilling the one or more execution goals. The one or more execution goals may comprise at least one of: collecting information from the customer at the customer device 110(1) to fulfill the use case, rephrasing a response to be sent to the customer at the customer device 110(1), or summarizing the information to be sent to the customer at the customer device 110(1), although other types and/or numbers of execution goals may be defined based on the use case. The one or more execution goals are determined based on the current one of the plurality of interconnected nodes of the dialog flow 210 being executed (e.g., the intent node, the entity node, the service node, the confirmation node, the message node, or the invoke-LLM node), although the execution goals may be determined based on any other types and/or numbers of nodes of the dialog flow 210. The one or more execution goals may be defined by the developer at the developer device 130(1) in the form of node properties while configuring the nodes of the dialog flow 210 as described with reference to the properties panel 212 in FIG. 2. In this example, with reference to FIG. 2, when the execution of the dialog flow 210 corresponding to the “Order Pizza” use case reaches the invoke-LLM node, the LLM selector 170 may select one of the plurality of LLMs 192(1)-192(n) that is configured to complete one or more execution goals of the dialog flow of the “Order Pizza” use case such as, for example, collecting information (e.g., size, type, base, toppings, quantity) from the customer at the customer device 110(1) that is required to place a pizza order.

The prompt generator 174 provides the plurality of prompts to the selected LLM 192(1) based on at least one of: static inputs 332 or dynamic inputs 334. The static inputs 332 may remain static throughout the conversation and the dynamic inputs 334 may change in real-time during the conversation between the customer at the customer device 110(1) and the virtual assistant server 150. The static inputs 332 may comprise at least one of: the use case context, the one or more business rules, the one or more conversation rules, the one or more exit scenarios, the few-shot sample conversations, and required output format, although the static inputs 332 may comprise other types and/or numbers of inputs based on the use case and/or the selected LLM 192(1). In this example, the selected LLM 192(1) is used to take pizza orders from the customers, and hence the use case context provided to the selected LLM 192(1) may comprise a brief description such as, for example, “Act like a pizza virtual assistant and take pizza orders from the customers”.

The dynamic inputs 334 provided to the prompt generator 174 may comprise at least one of: the customer utterance, the conversation context, the customer context, and the customer emotion, although the dynamic inputs 334 may comprise other types and/or numbers of inputs based on the use case and/or the selected LLM 192(1). Further, in one example, for the customer utterance, if any data such as, for example, a frequently asked question (FAQ), one or more documents, or the like is identified in the knowledge base 158, then the identified data may be retrieved from the knowledge base 158 and provided to the prompt generator 174 as part of the dynamic inputs 334. In one example, the static inputs 332 and dynamic inputs 334 are provided to the prompt generator 174 in text format or as structured data, although the static inputs 332 and dynamic inputs 334 may be provided in any other types and/or numbers of formats based on the type of the prompt generator 174 and/or the selected LLM 192(1) that are used. Further, the prompt generator 174 generates the one or more prompts in a format acceptable for the selected LLM 192(1).

Further, the selected LLM 192(1) analyzes the plurality of prompts, generates the plurality of outputs as part of completion of the one or more execution goals described in the plurality of prompts, and sends the generated plurality of outputs to the virtual assistant server 150 in the output format mentioned in the plurality of prompts. Each output of the plurality of outputs generated by the selected LLM 192(1) may comprise at least one of: a response to be transmitted to the customer at the customer device 110(1), goal status, or one or more entities extracted from the one or more customer utterances. Although not described each output of the plurality of outputs generated by the selected LLM 192(1) may comprise other types and/or numbers of data generated and/or collected from the customer by the selected LLM 192(1) based on the use case.

Further, the selected LLM 192(1) may also generate a summary of part of the customer conversation handled by the selected LLM 192(1) along with each output. In one example, the selected LLM 192(1) may include the generated summary as part of each output. In another example, the selected LLM 192(1) may separately transmit the generated summary and each output to the virtual assistant server 150. The summary of part of the customer conversation handled by the selected LLM 192(1) may be generated by the selected LLM 192(1) for each of the plurality of prompts received from the prompt generator 174. Further, the virtual assistant server 150 using the prompt generator 174, includes the summary generated by the selected LLM 192(1) along with the static inputs 332 and the dynamic inputs 334 in each successive prompt from a second one of the plurality of prompts provided to the selected LLM 192(1). For example, a first summary generated by the selected LLM 192(1) of part of the customer conversation handled by the selected LLM 192(1) after receiving a first prompt is provided as one of the inputs to the prompt generator 174. A second prompt provided to the selected LLM 192(1) by the prompt generator 174 comprises the first summary generated by the selected LLM 192(1) along with the static inputs 332 and the dynamic inputs 334 provided to the prompt generator 174 after receiving the first summary. Similarly, each of the successive prompts provided to the selected LLM 192(1) by the prompt generator 174 comprises the summary of part of the customer conversation handled by the selected LLM 192(1) thus far.

At step 308, when one or more of the plurality of outputs of the selected LLM 192(1) comprise: the one or more entities extracted from the one or more utterances and the response to be transmitted to the customer device, the virtual assistant server 150 using the validator 176, validates adherence of: the extracted one or more entities to one or more business rules; and the response to one or more conversation rules and/or the customer emotion, although other types and/or numbers of validations may be performed based on the type of the use case. In the pizza virtual assistant example, the validator 176 may validate the collected information-one or more entities (e.g., pizza type, pizza size, pizza crust, pizza base, etc.) in the output of the selected LLM 192(1) against the one or more business rules (e.g., menu) of the pizza store. In another example, the validator 176 may communicate with a software interface such as an application programming interface (API) of the pizza store and verify the availability of the collected information in the output of the selected LLM 192(1) with real-time inventory of the pizza store. In another example, the validator 176 may validate the response in the output of the selected LLM 192(1) against the one or more conversation rules defined and/or the customer emotion. In another example, the above described validations may be simultaneously performed by the validator 176.

At step 310, the virtual assistant server 150 may transmit the response of the one or more of the plurality of outputs of the selected LLM 192(1) to the customer device 110(1) when the corresponding validation is successful. In one example, each output of the plurality of outputs of the selected LLM 192(1) may be in the form of a JavaScript Object Notation (JSON) object, and when the validation is successful, the virtual assistant server 150 may process each JSON object to generate a response in textual form and transmit the response in textual form to the customer at the customer device 110(1).

In one example, upon successful validation of the output of the selected LLM 192(1) (i.e., the one or more entities extracted), the execution of the dialog flow 210 reaches the service node of the dialog flow 210, where a service call comprising the one or more entities extracted is placed using the API of the pizza store to place the pizza order for the customer. Upon receiving the order details from the pizza store via the API, the execution of the dialog flow 210 reaches the message node, where the virtual assistant server 150 transmits the order details received from the pizza store to the customer at the customer device 110(1). In one example, upon receiving the order details from the pizza store, the virtual assistant server 150 may prompt and invoke the selected LLM 192(1) again or a different LLM from the plurality of LLMs 192(1)-192(n) to generate the response comprising the order details to be transmitted to the customer at the customer device 110(1).

In one example, after selecting and invoking one of the plurality of LLMs 192(1)-192(n), i.e., the selected LLM 192(1), the steps 306, 308 and 310 are repeated by the virtual assistant server 150 until an indication of completion of the one or more execution goals is received from the selected LLM 192(1) for each of the series of interconnected nodes. In another example, in the process of completion of the one or more execution goals, when the selected LLM 192(1) encounters the one or more exit scenarios, the selected LLM 192(1) exits the process and indicates the encountered exit scenario to the virtual assistant server 150.

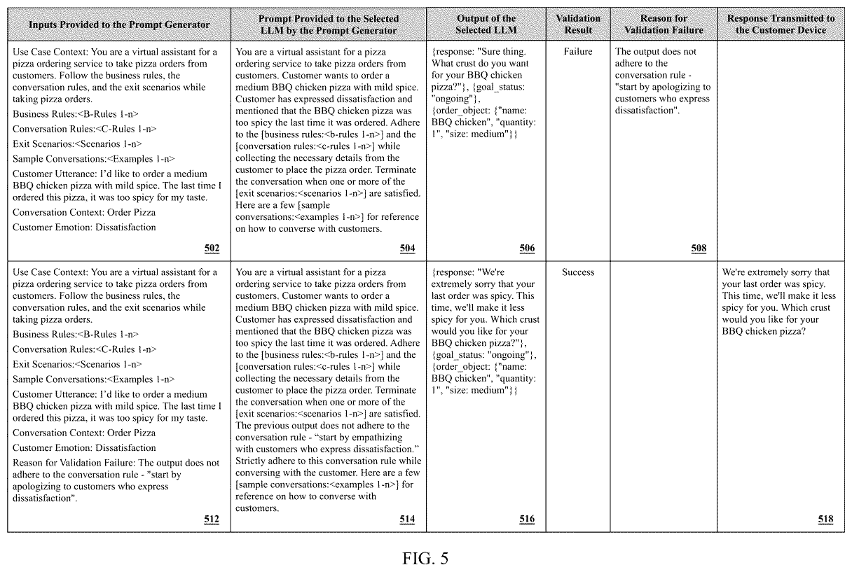

FIG. 3B is a flowchart of an exemplary method 320 for re-prompting the selected LLM 192(1) while orchestrating the customer conversation by the virtual assistant server 150. The exemplary method 320 may be performed by the system components illustrated in the environment 100 of FIG. 1A. At step 322, when the validation of an output of the selected LLM 192(1) fails, the validator 176 may generate a reason for validation failure 346 comprising at least one of: the one or more business rules not adhered to by the one or more entities extracted, or the one or more conversation rules not adhered to by the response. Further, at step 324, based on the inputs comprising: the reason for validation failure 346 received from the validator 176, the static inputs 332, and the dynamic inputs 334, the virtual assistant server 150 using the prompt generator 174 may re-prompt the selected LLM 192(1) to generate the output by overcoming the validation failure (as illustrated in FIG. 5). Thus, by validating outputs of the selected LLM 192(1) and re-prompting the selected LLM 192(1) with the reason for validation failure, the virtual assistant server 150 may ensure that only valid and reliable responses are sent to the customer at the customer device 110(1).

FIG. 3C is a flow diagram illustrating a few components of the environment 100 of FIG. 1A that interact with one another to implement the exemplary methods 300 and 320 for orchestrating the customer conversation. Although not illustrated in FIG. 3C, other components of the environment 100 may also be used to implement the exemplary methods 300 and 320 for orchestrating the customer conversation.

As illustrated in FIG. 3C, at step 330, based on the execution state of the dialog flow corresponding to the use case of the customer utterance, the LLM selector 170 selects one of the plurality of LLMs 192(1)-192(n). At step 336, the virtual assistant server 150 using the prompt generator 174, generates and provides a prompt to the selected LLM 192(1), where the prompt generated comprises at least one of the static inputs 332 or the dynamic inputs 334. At step 338, based on the received prompt, the selected LLM 192(1) generates and sends an output to the virtual assistant server 150. At step 340, the virtual assistant server 150 checks whether the goal status in the output of the selected LLM 192(1) is ongoing or completed.

If the goal status check is determined as completed, the virtual assistant server 150 understands that the selected LLM 192(1) has completed the one or more execution goals and hence the virtual assistant server 150 exits from the process of invoking the selected LLM 192(1). Further, if the goal status check is determined as not completed or ongoing, at step 344, the virtual assistant server 150 using the validator 176, validates adherence of the output of the selected LLM 192(1) as described at step 308 in FIG. 3A. If the validation of the output of the selected LLM 192(1) is successful, at step 348, the virtual assistant server 150 may transmit the response in the output of the selected LLM 192(1). If the validation of the output of the selected LLM 192(1) is a failure, at step 346, the validator 176 generates the reason for the validation failure 346, which is provided as an input to the prompt generator 174 along with the static inputs 332 and the dynamic inputs 334 for generating the prompt that instructs (re-prompts) the selected LLM 192(1) to consider the reason for the validation failure 346 while generating the output. In one example, the virtual assistant server 150 using the validator 176, validates only the output of the selected LLM 192(1) that comprises the goal status as “completed” and does not validate the output of the selected LLM 192(1) that comprises the goal status as “ongoing”. This ensures that the output of the selected LLM 192(1) is validated only when the selected LLM 192(1) completes the given execution goal. Further, the process of prompting the selected LLM 192(1), validating the output of the selected LLM 192(1), and transmitting the response to the customer at the customer device 110(1) is repeated until the goal status is identified as completed at step 340.

Further, as illustrated in FIG. 3C, for each received prompt from the prompt generator 174, the selected LLM 192(1) also generates a summary of part of the customer conversation 342 handled by the selected LLM 192(1) thus far. In one example, each prompt provided to the selected LLM 192(1) comprises an instruction to generate the summary of part of the customer conversation 342 handled by the selected LLM 192(1). Further, each successive prompt provided to the selected LLM 192(1) by the prompt generator 174 comprises the generated summary of part of the customer conversation 342 handled by the selected LLM 192(1) thus far. This process of instructing the selected LLM 192(1) to generate the summary of part of the customer conversation 342 handled by the selected LLM 192(1) and including the generated summary 342 in each successive prompt provided to the selected LLM 192(1) may improve reliability, interpretability, robustness, and performance of the selected LLM 192(1).

As illustrated in FIG. 3C, at step 344, the output generated by the selected LLM 192(1) for each received prompt from the prompt generator 174, is validated by the validator 176 before the response is transmitted (at step 348) to the customer at the customer device 110(1). This ensures that only the outputs of the selected LLM 192(1) which adhere to the one or more business rules or the one or more conversation rules defined by the enterprise are transmitted to the customer at the customer device 110(1). Also, as illustrated in FIG. 3C, when the validation of the output of the selected LLM 192(1) fails, the selected LLM 192(1) is re-prompted to generate the output by considering the reason for validation failure 346, which ensures that the selected LLM 192(1) adheres to all the business rules and the conversation rules set by the enterprise. Thus, the process of validation ensures to improve the accuracy and reliability of the output of the selected LLM 192(1), which in turn enhances the customer experience.

FIG. 3D is an example prompt provided to the selected LLM 192(1) by the prompt generator 174. The example prompt in FIG. 3D comprises the static inputs 332 such as the use case context 332(1), the one or more business rules 332(2), the one or more conversation rules 332(3), the one or more exit scenarios 332(4), and a few-shot example conversations 332(5). The example prompt may also comprise at least one of the dynamic inputs 334 (not illustrated in FIG. 3D) comprising the customer utterance 334(1), the customer context 334(2), the conversation context 334(3), or the customer emotion 334(4). Although not illustrated, the prompt may comprise other types and/or numbers of inputs based on the use case for which the selected LLM 192(1) is used for. From the provided few-shot example conversations 332(5), the selected LLM 192(1) learns what information is to be included in the output and in which format the output is to be generated. Further, as illustrated in FIG. 3D, from the pizza virtual assistant outputs 332(6a)-332(6c) in the few-shot example conversations 332(5), the selected LLM 192(1) may understand the format in which each output is to be generated. For example, each of the pizza virtual assistant outputs 332(6a)-332(6c) comprise: the summary of the part of the conversation handled by the pizza virtual assistant, the response to be transmitted to the customer, the goal status, and the order object. The order object comprises the one or more entities collected by the pizza virtual assistant from the customer.

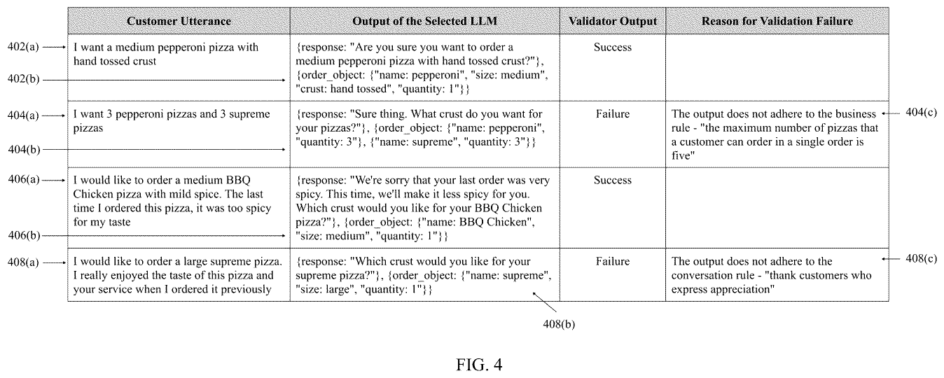

FIG. 4 illustrates example validations performed on the output of the selected LLM 192(1) by the validator 176 during the customer conversation between the customer at the customer device 110(1) and the pizza virtual assistant 166(1). As illustrated in FIG. 4, each output of the selected LLM 192(1) comprises a response to the customer utterance that is to be transmitted to the customer at the customer device 110(1) and an “order_object”, although each output of the selected LLM 192(1) may comprise other types and/or numbers of details.

As illustrated in FIG. 4, for a customer utterance 402(a)-“I want a medium pepperoni pizza with hand tossed crust”, the selected LLM 192(1) generates an output 402(b). The validator 176 parses the order_object present in the output 402(b) and validates the collected information (i.e., name, size, crust, and quantity) from the customer at the customer device 110(1) against the one or more business rules 332(2). In this example, the collected information adheres to the one or more business rules 332(2) (illustrated in FIG. 3D), and hence the validator 176 outputs “success” after the validation.

Further, as illustrated in FIG. 4, for a customer utterance 404(a)-“I want 3 pepperoni pizzas and 3 supreme pizzas”, the selected LLM 192(1) generates an output 404(b). The validator 176 parses the order_object in the output 404(b) and validates the collected information from the customer at the customer device 110(1) against the one or more business rules 332(2). In this example, the collected information does not adhere to a business rule-“the maximum number of pizzas that a customer can order in a single order is five” of the one or more business rules 332(2) (illustrated in FIG. 3D). Hence the validator 176 outputs “failure” after the validation and also generates a reason for the validation failure 404(c)-“The output does not adhere to the business rule-the maximum number of pizzas that a customer can order in a single order is five”. Subsequently, the virtual assistant server 150 provides the reason for the validation failure 404(c) as one of the inputs to the prompt generator 174, which re-prompts the selected LLM 192(1) to overcome the validation failure 404(c). This feedback mechanism of providing the reason for the validation failure 404(c) to the selected LLM 192(1) may improve the accuracy and the reliability of the output of the selected LLM 192(1).

Further, as illustrated in FIG. 4, for a customer utterance 406(a)-“I would like to order a medium BBQ Chicken pizza with mild spice. The last time I ordered this pizza, it was too spicy for my taste”, the selected LLM 192(1) generates an output 406(b). Upon processing the customer utterance 406(a), the virtual assistant server 150 determines that the customer expressed negative emotion. Along with the output 406(b), the customer's emotion is also provided to the validator 176 for validation. The validator 176 parses the order_object in the output 406(b) and validates the collected information (i.e., name, size, and quantity) from the customer at the customer device 110(1) against the one or more business rules 332(2) and determines that the collected information adheres to the one or more business rules 332(2) (illustrated in FIG. 3D). Further, as the customer expressed negative emotion, the validator 176 also validates the response in the output 406(b) against the one or more conversation rules 332(3) (illustrated in FIG. 3D) and determines that the response in the output 406(b) adheres to the one or more conversation rules. As the output 406(b) adheres to the one or more business rules 332(2) and the one or more conversation rules 332(3), the validator 176 outputs “success” after the validation.

Further, as illustrated in FIG. 4, for a customer utterance 408(a)-“I would like to order a large supreme pizza. I really enjoyed the taste of this pizza and your service when I ordered it previously”, the selected LLM 192(1) generates an output 408(b). Upon processing the customer utterance 408(a), the virtual assistant server 150 determines that the customer expressed appreciation. Along with the output 408(b), the customer's emotion (i.e., appreciation) is also provided to the validator 176 for validation. The validator 176 parses the order_object in the output 408(b) and validates the collected information (i.e., name, size, and quantity) from the customer at the customer device 110(1) against the one or more business rules 332(2) and determines that the collected information adheres to the one or more business rules 332(2) (illustrated in FIG. 3D). Further, as the customer expressed appreciation, the validator 176 also validates the response in the output 408(b) against the one or more conversation rules 332(3) (illustrated in FIG. 3D) and determines that the response in the output 408(b) does not adhere to the conversation rule-“thank customers who express appreciation”. Although the output 408(b) adheres to the one or more business rules 332(2), as the output 408(b) does not adhere to the one or more conversation rules 332(3), the validator 176 outputs “failure” after the validation. Further, the validator 176 generates a reason for the validation failure 408(c)-“The output does not adhere to the conversation rule-thank customers who express appreciation”. Further, the virtual assistant server 150 provides the reason for the validation failure 408(c) as one of the inputs to the prompt generator 174, which re-prompts the selected LLM 192(1) to overcome the validation failure.

FIG. 5 is an example illustrating validation performed on the output of the selected LLM 192(1) and re-prompting the selected LLM 192(1) when the validation fails during the customer conversation. As illustrated in FIG. 5, based on inputs 502, the prompt generator 174 provides a prompt 504 to the selected LLM 192(1), based on which the selected LLM 192(1) generates an output 506. Upon receiving the output 506 from the selected LLM 192(1), the virtual assistant server 150 using the validator 176 validates the entities (i.e., “name: BBQ chicken”, “quantity: 1”, “size: medium”) in the order_object of the output 506 against the business rules (i.e., “B-Rules 1-n”) and a response (“Sure thing. What crust do you want for your BBQ chicken pizza?”)

of the output 506 against the conversation rules (i.e., “C-Rules 1-n”). As the customer expressed dissatisfaction (illustrated as “customer emotion: dissatisfaction” in the inputs 502) and as the response of the output 506 does not address the customer emotion, upon validating the output 506, the validator 176 determines that the response of the output 506 does not adheres to one of the conversation rules. Hence the validator 176 outputs a failure and further generates a reason for validation failure 508 (i.e., The output does not adhere to the conversation rule-“start by apologizing to customers who express dissatisfaction”). Further, as the validator 176 outputs failure, the virtual assistant server 150 will not transmit the response of the output 506 to the customer.

Further, the virtual assistant server 150 provides the reason for validation failure 508 as part of inputs 512 to the prompt generator 174. As illustrated in FIG. 5, the inputs 512 comprises the inputs 502 and the reason for validation failure 508. Based on inputs 512, the prompt generator 174 provides a prompt 514 (which is a re-prompt) to the selected LLM 192(1). The prompt 514 comprises the reason for validation failure 508 and an instruction (“strictly adhere to this conversation rule while conversing with the customer”) to the selected LLM 192(1). Further, based the prompt 514, the selected LLM 192(1) generates an output 516. Upon receiving the output 516 from the selected LLM 192(1), the virtual assistant server 150 using the validator 176 validates the entities (i.e., “name: BBQ chicken”, “quantity: 1”, “size: medium”) in the order_object of the output 516 against the business rules (i.e., “B-Rules 1-n”) and a response (“We're extremely sorry that your last order was spicy. This time, we'll make it less spicy for you. Which crust would you like for your BBQ chicken pizza?”) of the output 516 against the conversation rules (i.e., “C-Rules 1-n”). As the customer expressed dissatisfaction (illustrated as “customer emotion: dissatisfaction” in the inputs 512) and as the response of the output 516 addresses the customer emotion by apologizing the customer and adheres to all the conversation rules (i.e., “C-Rules 1-n”), upon validating the output 516, the validator 176 outputs success. Further, as the validator 176 outputs success, the virtual assistant server 150 transmits the response (“We're extremely sorry that your last order was spicy. This time, we'll make it less spicy for you. Which crust would you like for your BBQ chicken pizza?”) of the output 516 to the customer. Thus, by validating the outputs of the selected LLM 192(1) before transmitting to the customer and providing the reason for the validation failure as a feedback to the selected LLM 192(1) may ensure the reliability of the outputs of the selected LLM 192(1).

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method for orchestrating a customer conversation by a virtual assistant server, the method comprising:
executing a dialog flow corresponding to a use case of one or more utterances received from a customer device, wherein the dialog flow comprises a series of interconnected nodes;
selecting a large language model (LLM) from a plurality of LLMs to perform response generation for the one or more utterances received from the customer device based on an execution state of the dialog flow;
receiving a plurality of outputs from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device;
when one or more of the plurality of outputs of the selected one of the plurality of LLMs comprise: the one or more entities extracted from the one or more utterances and the response to be transmitted to the customer device, validating adherence of:
the extracted one or more entities to one or more business rules; and
the response to one or more conversation rules; and
transmitting the response of the one or more of the plurality of outputs of the selected one of the plurality of LLMs to the customer device when the corresponding validation is successful.

2. The method of claim 1, further comprising:
determining the execution state of the dialog flow of the use case in the series of interconnected nodes, wherein the series of interconnected nodes comprise: an entity node, a service node, a confirmation node, a message node, and an invoke LLM node.

3. The method of claim 1, further comprising:
when the validation fails:
generating, by the virtual assistant server, a reason for the validation failure comprising at least one of:
the one or more business rules not adhered to by the one or more entities extracted; or
the one or more conversation rules not adhered to by the response; and
re-prompting, by the virtual assistant server, the selected one of the plurality of LLMs to overcome the validation failure based on at least the generated reason for the validation failure.

4. The method of claim 1, wherein the receiving, the validating, and the transmitting are repeated until an indication of completion of the one or more execution goals is received from the selected one of the plurality of LLMs.

5. The method of claim 1, wherein each of the plurality of prompts comprises an instruction for the selected one of the plurality of LLMs to generate a summary of part of the customer conversation handled by the selected one of the plurality of LLMs, and wherein each successive prompt from a second one of the plurality of prompts comprises the generated summary.

6. A virtual assistant server comprising:
one or more processors; and
a memory coupled to the one or more processors which are configured to execute programmed instructions stored in the memory to:
execute a dialog flow corresponding to a use case of one or more utterances received from a customer device, wherein the dialog flow comprises a series of interconnected nodes;
select a large language model (LLM) from a plurality of LLMs to perform response generation for the one or more utterances received from the customer device based on an execution state of the dialog flow;
receive a plurality of outputs from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device;
when one or more of the plurality of outputs of the selected one of the plurality of LLMs comprise: the one or more entities extracted from the one or more utterances and the response to be transmitted to the customer device, validate adherence of:
the extracted one or more entities to one or more business rules; and
the response to one or more conversation rules; and
transmit the response of the one or more of the plurality of outputs of the selected one of the plurality of LLMs to the customer device when the corresponding validation is successful.

7. The virtual assistant server of claim 6, wherein the one or more processors are further configured to execute programmed instructions stored in the memory to:
determine the execution state of the dialog flow of the use case in the series of interconnected nodes, wherein the series of interconnected nodes comprise: an entity node, a service node, a confirmation node, a message node, and an invoke LLM node.

8. The virtual assistant server of claim 6, further comprising:
when the validation fails, the one or more processors are further configured to execute the programmed instructions stored in the memory to:
generate a reason for the validation failure comprising at least one of:
the one or more business rules not adhered to by the one or more entities extracted; or
the one or more conversation rules not adhered to by the response; and
re-prompt the selected one of the plurality of LLMs to overcome the validation failure based on at least the generated reason for the validation failure.

9. The virtual assistant server of claim 6, wherein the one or more processors are further configured to execute the programmed instructions stored in the memory to: repeat the receive, the validate, and the transmit steps until an indication of completion of the one or more execution goals is received from the selected one of the plurality of LLMs.

10. The virtual assistant server of claim 6, wherein each of the plurality of prompts comprises an instruction for the selected one of the plurality of LLMs to generate a summary of part of the customer conversation handled by the selected one of the plurality of LLMs, and wherein each successive prompt from a second one of the plurality of prompts comprises the generated summary.

11. A non-transitory computer-readable medium storing instructions which when executed by one or more processors, causes the one or more processors to:
execute a dialog flow corresponding to a use case of one or more utterances received from a customer device, wherein the dialog flow comprises a series of interconnected nodes;
select a large language model (LLM) from a plurality of LLMs to perform response generation for the one or more utterances received from the customer device based on an execution state of the dialog flow;
receive a plurality of outputs from the selected one of the plurality of LLMs to fulfill one or more execution goals of the dialog flow based on a plurality of prompts provided to the selected one of the plurality of LLMs, wherein each of the plurality of outputs of the selected one of the plurality of LLMs comprises at least one of: one or more entities extracted from the one or more utterances or a response to be transmitted to the customer device;
when one or more of the plurality of outputs of the selected one of the plurality of LLMs comprise: the one or more entities extracted from the one or more utterances and the response to be transmitted to the customer device, validate adherence of:
the extracted one or more entities to one or more business rules; and
the response to one or more conversation rules; and
transmit the response of the one or more of the plurality of outputs of the selected one of the plurality of LLMs to the customer device when the corresponding validation is successful.

12. The non-transitory computer-readable medium of claim 11, wherein the one or more processors are further configured to execute the instructions stored in the non-transitory computer-readable medium to: determine the execution state of the dialog flow of the use case in the series of interconnected nodes, wherein the series of interconnected nodes comprise: an entity node, a service node, a confirmation node, a message node, and an invoke LLM node.

13. The non-transitory computer-readable medium of claim 11, further comprising:
when the validation fails, the one or more processors are further configured to execute the instructions stored in the non-transitory computer-readable medium to:
generate a reason for the validation failure comprising at least one of:
the one or more business rules not adhered to by the one or more entities extracted; or
the one or more conversation rules not adhered to by the response; and
re-prompt the selected one of the plurality of LLMs to overcome the validation failure based on at least the generated reason for the validation failure.

14. The non-transitory computer-readable medium of claim 11, wherein the one or more processors are further configured to execute the instructions stored in the non-transitory computer-readable medium to: repeat the receive, the validate, and the transmit steps until an indication of completion of the one or more execution goals is received from the selected one of the plurality of LLMs.

15. The non-transitory computer-readable medium of claim 11, wherein each of the plurality of prompts comprises an instruction for the selected one of the plurality of LLMs to generate a summary of part of the customer conversation handled by the selected one of the plurality of LLMs, and wherein each successive prompt from a second one of the plurality of prompts comprises the generated summary.
